(19) United States
(12) Patent Application Publication
(10) Pub. No.: US 2016/0311684 A1
(43) Pub. Date: Oct. 27, 2016

(54) METHOD FOR REFORMING MIXTURES OF HYDROCARBONS AND CARBONDIOXIDE

(71) Applicant: BASF SE, Ludwigshafen (DE)

(72) Inventors: Andrian MILANOV, Mannheim (DE); Ekkehard SCHWAB, Neustadt (DE); Heiko URTEL, Bobenheim-Roxheim (DE); Stephan SCHUNK, Heidelberg (DE); Guido WASSERSCHAFF, Neckargemünd (DE)

(21) Appl. No.: 15/105,464

(22) PCT Filed: Dec. 15, 2014
(86) PCT No.: PCT/EP2014/077673

§ 371 Date: Jun. 16, 2016

(30) Foreign Application Priority Data
Dec. 20, 2013 (EP) 13199113.5

(51) Int. Cl. C01B 3/40; C01B 3/38

(52) U.S. Cl. CPC C01B 3/40; C01B 3/382; C01B 2203/0238; C01B 2203/0233; C01B 2203/061; C01B 2203/062; C01B 2203/1082; C01B 2203/1064; C01B 2203/1058; C01B 2203/1052; C01B 2203/1241; C01B 2203/142

(57) ABSTRACT

A method of reforming mixtures of hydrocarbons, preferably methane, and carbon dioxide, wherein the method comprises at least two stages. In a first stage, a reactant gas is contacted with a precious metal catalyst and converted to a first product gas (also referred to hereinafter as product gas 1). In a second stage, the first product gas obtained in the first stage is contacted with a non-precious metal catalyst and converted to a second product gas (also referred to hereinafter as product gas 2). The process can also include adding gases to the product gas 1 obtained in the first stage. The practice of the process can minimize the formation of coke on the catalyst in an efficient manner. The combination of a first stage with a precious metal catalyst and at least one second stage with non-precious metal catalyst allows considerable amounts of costly precious metals to be saved.

The present invention relates to a method of reforming mixtures of hydrocarbons, preferably methane, and carbon dioxide. In a first method stage, a reactant gas is contacted with a precious metal catalyst and converted to a first product gas (also referred to hereinafter as product gas 1). In at least one further method stage, the first product gas obtained in the first method stage is contacted with a non-precious metal catalyst and converted to a second product gas (also referred to hereinafter as product gas 2). It is possible to add further gases to the product gas 1 obtained in the first method stage, before it is then converted further in the at least second method stage.

The gas which is added to the first product gas may, for example, be gas originating from the reactant gas reservoir and/or gas originating from a recycle gas stream (from the process itself). The conversion of the first product gas (i.e. product gas 1) in the second method stage leads to formation of the second product gas (i.e. product gas 2). The second product gas can subsequently be converted further in one or else more than one further method stages. The reactant gas used for the first method stage comprises a mixture of hydrocarbons, preferably methane, and carbon dioxide, and has the characteristic feature that it has a low water content or is anhydrous. The reactant gas is characterized by a preferred ratio of water vapor molecules to carbon atoms in the hydrocarbon used (i.e. n_{H2O}/n_{c.a.n.} ratio), where the n_{H2O}/n_{c.a.n.} ratio is <1, preferably <0.5, further preferably <0.2, particularly preferably <0.1, additionally preferably <0.05, and especially preferably <0.02 (the number of carbon atoms is 1 for methane, two for ethane and three for propane, etc.).

It is additionally preferable that the total content of water vapor in the reactant gas is <50% by volume, preferably <25% by volume, further preferably <15% by volume, even further preferably <10% by volume, further preferably again <5% by volume, additionally preferably <3% by volume and especially preferably <1% by volume. In an even further preferred embodiment, the reactant gas is anhydrous (which corresponds, in the industrial application, to a water vapor content of <0.005% by volume). In relation to “anhydrous”, it should be mentioned that small amounts of water vapor are not completely ruled out. However, no additions of water vapor are added to the reactant gas.

The reactant gas may also comprise up to 30% by volume of hydrogen, where the figure is based on the total volume of reactant gas. In a preferred embodiment of the process, the hydrogen content in the reactant gas is <20% by volume, preferably <10% by volume, further preferably <5% by volume, even further preferably <3% by volume and especially preferably <1% by volume. In a further preferred embodiment, the reactant gas is hydrogen-free.

It is a characteristic feature of the method of the invention that the hydrocarbons present in the reactant gas are not fully converted in the first method stage. The hydrocarbon conversion in the first method stage is preferably in the range of 1%-80%, further preferably in the range of 2%-60%, even further preferably in the range of 3%-50%, particularly preferably in the range of 4%-45% and especially preferably in the range of 5%-40%. In a further particularly preferred embodiment of the process, the hydrocarbon conversion in the first method stage is in the range of 10%-35%.

The reforming of methane and carbon dioxide is of great economic interest, since it is possible by means of this method to prepare synthesis gas. Synthesis gas constitutes a raw material for the production of chemical commodities. Furthermore, the utilization of carbon dioxide as a starting material in chemical syntheses is of significance, in order to bind carbon dioxide which occurs as a waste product in numerous processes by a chemical route and hence to avoid emission into the atmosphere.

In accordance with its great economic significance, the reforming of hydrocarbons in the presence of carbon dioxide forms the subject matter of numerous publications. There follows a brief overview of the areas of focus within these publications.

U.S. Pat. No. 8,043,530 B2 to Umicore (the inventors nominated are L. Chen and J. G. Weissman) relates to a fuel reforming catalyst and claims a method of producing a hydrogen-containing reformate, in which a hydrocarbon-containing fuel is contacted with a two-stage catalyst present within a reaction vessel. According to the disclosure, the first stage comprises Pt or Ir as precious metal component. The second catalyst stage comprises either Ni together with Ir or Ni together with Pd. In addition, Rh may also be present in the second catalyst stage, in which case the Rh content is not greater than 0.5% by weight. The method relates to the performance of partial oxidation reactions, steam reforming reactions or autothermal reforming reactions.

Row-by-row or graduated arrangements with reforming spaces are known in the prior art, in order to convert gas mixtures comprising fuels, water and air, for example, to hydrogen-rich fuels which are required for the operation of fuel cells.

EP 1245 532 (applicant: Ishikawajima-Harima Heavy Industries) discloses a method and an apparatus for conversion of gas mixtures comprising fuel, steam and air to a fuel comprising hydrogen, the application being directed mainly to the automotive sector. The first catalytic stage includes a reaction that proceeds exothermically in conjunction with a catalyst 8a and a subsequent reforming of the gas mixture obtained with a reforming catalyst 8b present in the immediate proximity of the oxidation catalyst 8a. The specific technical arrangement of the catalysts 8a and 8b results in heat exchange effects between reaction stages proceeding exothermically and endothermically.

EP 2 022 756 A2 (applicant: Delphi Technologies) discloses and claims a graduated hydrocarbon reformer, in which a catalytic reformer is used to reform hydrocarbon fuels and oxygen to reformates comprising hydrogen and carbon monoxide. The majority of reforming stages comprises exothermic and endothermic stages, these being arranged in a flow sequence and each comprising substrates to which the catalytic materials have been applied. The individual method stages have catalytic properties which differ from the other stage in each case. It is also preferable here that the catalytic properties of the first stage are lower than the properties of the last stage.

RU 2 274 600 C1 discloses a multistage reforming method in which the streams comprising lower alkanes having about 1 to 34 carbon atoms are passed through a heat exchanger. The conduits of the heat exchanger are arranged in an adiabatically operated reactor with catalyst packing. Upstream of the first reaction stage and between the individual reaction stages, the gas stream is mixed with water vapor and/or carbon dioxide and is cooled at the end of each stage. At the end of the last stage, the stream is treated to remove the water vapor. The utilization of carbon dioxide as a starting material in the performance of reforming reactions with hydrocarbons for production of synthesis gas and the conversion of the latter to commodity chemicals is of great economic and industrial significance. Carbon dioxide has been identified as a greenhouse gas for a few decades and these effects have been repeatedly confirmed. The reduction of carbon dioxide emission into the atmosphere constitutes a great technical challenge for research in order to establish more climate-friendly processes.

A further technical challenge is the efficient conversion of primary energy sources such as natural gas to higher-value chemicals and fuels having higher energy density that are easier to transport than gases.

The catalytic reaction of hydrocarbons with steam, known as steam reforming, is a process established on the industrial scale for the production of synthesis gas (a mixture of H₂ and CO). The synthesis gas obtained can subsequently be converted to (higher-value) chemicals or to (higher-value) fuels. Examples of these include the preparation of methanol, dimethyl ether, acetic acid, Fischer-Tropsch fuels, olefins, etc. In the steam reforming process, it is customary to use a high excess of steam in order to suppress the coking of the typically nickel-containing catalyst. One overview of hydrogen and synthesis gas production via steam reforming is given in a publication by York et al. (A. P. E. York, T. Xiao, M. L. H. Green, Catal. Rev., 49, (2007) p. 511-560).

Steam reforming reaction: CH₄+H₂O [symbol] CO+3H₂

The reforming of hydrocarbons with CO₂ rather than H₂O, known as dry reforming, is an attractive alternative to steam reforming, since it constitutes a route for chemical utilization of CO₂ and simultaneously affords a synthesis gas having a low H₂/CO ratio which is particularly suitable for the synthesis of methanol, DME, acetic acid, higher alcohols and also for the Fischer-Tropsch synthesis of long-chain hydrocarbons and olefins. In the case of use of methane as starting material, dry reforming constitutes an attractive route for the chemical conversion of no fewer than two greenhouse gases, namely CH₄ and CO₂. However, the absence of water vapor constitutes a great challenge which, because of the anhydrous process conditions, leads to rapid coking and failure of the catalyst, which makes industrial use of the method uneconomic.

An overview of carbon dioxide reforming of methane is given in a publication by Bradford et al. (M. C. J. Bradford, M. A. Vannice; Catal. Rev.-Sci. Eng., 41 (1) (1999) p. 1-42). Dry reforming reaction: CH₄+CO₂ [symbol] 2CO+2H₂

One of the objects of the invention was to provide a catalytic method of synthesis gas production which has improved economic viability, high energy efficiency and a much lower tendency to formation of coke on the catalyst compared to the methods known from the prior art. It was also a further object to provide a catalytic method with the aid of which carbon dioxide can be converted chemically. By virtue of the improved utilization of carbon dioxide, the intention is to find a route which can contribute to reducing the emission of carbon dioxide into the atmosphere. At the same time, there is also an interest in developing a reforming method having better technical implementability than reforming methods currently being operated.

In order to achieve the objects mentioned here, a method of reforming reactant gas comprising hydrocarbons and CO₂ is provided, wherein the hydrocarbon present in the reactant gas is preferably methane and wherein the method of the invention comprises at least two stages characterized at least by the following method stages:
(i) contacting a reactant gas with precious metal catalyst (cat. 1) to form product gas 1, the reactant gas comprising at least hydrocarbons, preferably methane, and CO₂ and optionally water vapor, where the ratio of water vapor to carbon atoms (i.e. the n_{H2O}/n_{c.a.n.} ratio) is <1, preferably <0.5, further preferably <0.2, particularly preferably <0.1, more particularly preferably <0.05, and especially preferably <0.02, where the water vapor content in the reactant gas is <50% by volume, preferably <25% by volume, further preferably <15% by volume, further preferably <10% by volume, particularly preferably <5% by volume, more particularly preferably <3% by volume, and especially preferably <1% by volume, and the reactant gas also optionally comprising up to 30% by volume of hydrogen based on the total reactant gas volume, preferably <20% by volume, further preferably <10% by volume, even further preferably <5% by volume, particularly preferably <3% by volume, and especially preferably <1% by volume,
(ii) contacting product gas 1 from the first method stage with one or more non-precious metal catalyst(s) (i.e. cat. 2, cat. 3, etc.) in at least one further method stage to form product gas 2, using product gas 1 directly or after addition of gas, the added gas preferably being reactant gas and/or recycle gas.

It is a characteristic feature of the method of the invention that reactant gases comprising a high proportion of carbon dioxide and hydrocarbons are converted, the hydrocarbons preferably being methane. At the same time, the reactant gases comprise only small amounts of water or are entirely anhydrous. However, the method of the invention can be conducted with any hydrocarbons that are in the gas phase under the particular method conditions. It should be emphasized that, in conjunction with the method of the invention, the coking of the catalyst material is prevented, even though the reactant gas is virtually anhydrous or completely anhydrous. The inventive combination of a suitable precious metal catalyst in the first method stage, where only a partial conversion of the hydrocarbons used is achieved, with one or more suitable non-precious metal catalyst(s) in the second or further method stages, where the hydrocarbons used are converted completely (or to the or close to the thermodynamic equilibrium), makes the method of the invention is more economic compared to conventional methods for the conversion of hydrocarbons and CO₂ to synthesis gas which use exclusively precious metal catalysts. The conversion of high proportions of carbon dioxide is of significance, since this enables efficient utilization of carbon dioxide. The proportion of the carbon dioxide molecules used in the reactant gas may be about as high as the number of hydrocarbon atoms present in the reactant gas. It is also conceivable that the number of carbon dioxide molecules is higher than the hydrocarbon atoms, which means that the H₂ to CO ratio of the synthesis gas obtained can be influenced or adjusted.

The hydrocarbons present in the reactant gas may be selected from the group of methane, ethane, ethene, propane, butane, pentane and higher alkanes.

The number of carbon atoms or carbon number present in the particular hydrocarbon used (the number is abbreviated in the present disclosure to carbon atoms number or c.a.n.) is a characteristic parameter of significance for the composition of the reactant gas or for the addition of CO₂.

Methane has the carbon number of one, while ethane has the carbon number of two and propane the carbon number of three. In relation to methane, the number of moles of carbon atoms per mole of methane is consequently 1 (i.e. n_{c.a.n.}=1); in the case of ethane, the number of moles of carbon atoms per mole of ethane is two (i.e. n_{c.a.n.}=2). For the number of moles of carbon atoms, the concentration of the hydrocarbons in the reactant gas should also be taken into account. If a mixture of methane and ethane is present and these molecules are present with the same concentration, the result is a number of carbon atoms of n_{c.a.n.}=1.5. It should be noted that the parameter cited relates to the carbon atoms in the hydrocarbons, not to the carbons in the carbon dioxide also present in the reactant gas.

The molar amount of carbon atoms in the hydrocarbons present in the reactant gas is significant in relation to the method of the invention, since it is in a specific relationship with the molar amount of water which is used for the method of the invention. An essential aspect of the reforming method of the invention is that it can be conducted with a very low water vapor content in the reactant gas or else with an anhydrous reactant gas.

The method of the invention can thus be operated under conditions with a very low water vapor level. In a preferred embodiment of the method of the invention, the reactant gas used for the first method stage has a ratio of water vapor to carbon atoms (i.e. n_{H2O}/n_{c.a.n.} ratio) of <1, preferably <0.5, further preferably <0.2, particularly preferably <0.1, more particularly preferably <0.05, and especially preferably <0.02.

In a preferred embodiment, the method is conducted with an “anhydrous” reactant gas, which corresponds in the industrial application to a water content of <0.005% by volume. Small amounts of water may be present, for example, in the hydrocarbon source, but no additions of water vapor are added thereto.

In this respect, it should be mentioned that a reactant gas low in water vapor is very difficult to handle from an industrial point of view, since it results in an increased tendency to form coke and deposition of coke on the catalyst, which therefore disrupts the method and generally prevents long-term stability of the method. Only by means of very costly precious metal catalysts is it possible to prevent the deposition of coke on the catalyst during the method, in order thus to be able to manage a reforming method in the presence of small amounts of water vapor industrially at all and make it implementable. The technical demands that are placed on the catalyst system are enormously high when they are implemented in a method having only small amounts of water vapor in the reactant gas.

Several different catalyst systems and methods are published in the prior art, these being based on precious metal catalysts and permitting operation in the operating state with a low water vapor level. However, it has not been possible to date to achieve industrial scale use of these on precious metal catalysts, since the use of costly precious metals is too expensive and they cannot compete with those methods based on non-precious metal catalysts.

An essential element of the present invention is the combination of at least two different method steps to give an integral method. In a first method stage, a reactant fluid is reacted with a precious metal catalyst to give a first product gas and the first product gas is then contacted in a second method stage with a non-precious metal catalyst and converted to a second product gas. The second method step may be followed by a third method step.

The method of the invention and the combination of at least two method stages comprising a first method stage with precious metal catalyst (cat. 1) and at least one further method stage with non-precious metal catalyst (cat. 2, cat. 3, etc.) which is present therein, in terms of hydrocarbon reforming, give rise to a synergistic effect which brings a technical benefit.

In a further and preferred embodiment of the method of the invention for reforming gas mixtures, the catalysts used for the method are present in the first and/or second stage as tablets or shaped bodies having a side crushing strength of >40 N, the side crushing strength preferably being >70 N, the side crushing strength further preferably being >100 N, and the side crushing strength even further preferably being >150 N.

It is particularly preferable in the first stage when the reactant gas is contacted with a precious metal catalyst which is in tablet form and in which the side crushing strength of the tablets is >40 N, preferably >70 N, further preferably >100 N, even further preferably >150 N. It is particularly preferable in the second stage when the product gas from the first method stage is contacted with a non-precious metal catalyst which is in tablet form and in which the side crushing strength of the tablets is >40 N, preferably >70 N, further preferably >100 N, even further preferably >150 N. For further method stages too, it is possible that the catalysts used in each in tablet form and the side crushing strength of the tablets is >40 N, preferably >70 N, further preferably >100 N, even further preferably >150 N.

The term “tablets” or “shaped bodies” encompasses cylindrical shaped bodies, prisms, skewed common cylinders. The cylinders may have base surfaces arranged in parallel. The base surfaces have a certain separation which is referred to hereinafter as length of the shaped cylindrical body or of the tablet. In particular configurations, the base surfaces are arranged in parallel. Aside from that, the base surfaces may also be circular. It is thus possible to assign a diameter to the base surfaces. In the case of a base surface in the form of an ellipse, the diameter is found from the mean value of the diameter, since the elliptical surface can have different diameters. Also possible and included within the term are forms of a skewed common cylinder.

It should additionally be stated that the catalysts which are preferably used conjunction with the method of the invention are in the form of tablets having a high side crushing strength, the tablets displaying a diameter of >5 mm, preferably >8 mm, more preferably >10 mm, especially >13 mm. In a preferred method, the catalysts used have a length of >5 mm, preferably >8 mm, more preferably >10 mm, especially >13 mm. It can be stated that the method of the invention is preferably conducted with catalysts in tablet form having a high side crushing strength, wherein the ratio of diameter to length (i.e. D/L ratio) is within a range from 2.5 to 0.4, the D/L ratio preferably being within a range from 2.1 to 0.6, the D/L ratio more preferably being within a range from 1.9 to 0.8, and the D/L ratio especially preferably being within the range from 1.8 to 1.0.

In a further-preferred embodiment, the catalysts in the form of tablets have one or more channels which may extend, for example, along the longitudinal axis of the shaped catalyst body (identical to the longitudinal axis of the catalyst tablet). On account of the channels, it is possible to increase the surface area of the catalyst tablets (or of the shaped body) in the macroscopic dimension and to lower the pressure drop and the density or the weight of the shaped catalyst body without any occurrence of lowering of the compressive strength of the shaped catalyst body. The performance of the method of the invention is particularly advantageous when the catalysts are used in the form of tablets which have at least one channel along the longitudinal axis, preferably at least two channels along the longitudinal axis, more preferably at least three channels along the longitudinal axis, and especially at least four channels along the longitudinal axis.

The side crushing strength is determined with a commercially available measurement apparatus (for example, it is possible to use an apparatus from Zwick (Zwick tester)). A measurement of the side crushing strength is obtained by testing a number of about 25 catalyst tablets from a representative sample in relation to their side crushing strength. The individual measurements are successive, each measurement involving placing one tablet with the rounded lateral face onto the planar metal contact plate of the corresponding measurement device (in the present case a ZWICK tester). The two plane-parallel outer faces are therefore in the vertical direction. Thereafter, a planar metal die is moved onto the shaped catalyst body from above at an advance rate of 1.6 mm/min and the force acting on the catalyst tablet until it fractures is recorded against time. The side crushing strength of the individual catalyst tablets corresponds to that force which is measured at the time of fracture of the tablet (at the maximum force) on the tablet.

In addition, it is also possible to add gases to the particular product gases before they are converted further in the next method stage.

The method of the invention offers the advantage that it is necessary to use only small amounts of precious metal catalyst (cat. 1) overall, and only for the first method stage. This method stage enables the production of a first product gas wherein a water vapor content or the content thereof of hydrogen and water vapor (i.e. H₂+H₂O content) is sufficiently high to be converted in subsequent method stages in conjunction with non-precious metal catalysts without coking.

It is a characteristic feature of the method of the invention that, in the first method stage with the precious metal catalyst (cat. 1), the hydrocarbons present in the reactant gas are not fully converted. The hydrocarbon conversion achieved in method stage 1 is preferably 1-80%, further preferably 2-60%, even further preferably 3-50%, particularly preferably 4-45%, especially preferably 5-40%. In a further particularly preferred embodiment of the method, the hydrocarbon conversion is in the range of 10-35%.

It is a characteristic feature of the product gas obtained in the conversion of the reactant gas over the precious metal catalyst in the method stage (i.e. product gas 1) that it comprises, as essential constituents, methane or unconverted hydrocarbon, hydrogen, carbon monoxide, carbon dioxide and water vapor.

Product gas 1 from the first method stage can be converted directly and/or after addition of gas in at least one further method stage. The gas added may, for example, be reactant gas and/or recycle gas. In the at least second or further method stages, the product gas can be contacted with a plurality of non-precious metal catalysts (cat. 2, cat. 3, etc.) and be converted to the second product gas. The latter can in turn be converted in a third method stage, in contact with a non-precious metal catalyst, to a third product gas (i.e. product gas 3).

In a preferred embodiment of the method of the invention, it is a characteristic feature of product gas 1 or the mixture of product gas 1 and further gas prior to contacting with at least one non-precious metal catalyst (cat. 2, cat. 3, etc.) that it has a water vapor content or a content of water vapor and hydrogen within an advantageous range. Preferably, product gas 1 has a water vapor content or a content of water vapor and hydrogen in the range from 3% to 60% by volume, preferably in the range from 5% to 50% by volume, further preferably in the range from 7% to 30% by volume, further preferably from 8% to 25% by volume and especially preferably in the range from 9% to 23% by volume. In other words, the stated ranges are based only on water vapor if a hydrogen-free product gas is present, or on the sum of water vapor and hydrogen if a product gas comprising both water vapor and hydrogen is present. It should also be mentioned that it is the first product gas to which gases can but need not necessarily be added.

Several technical configurations of the method of the invention are shown in FIGS. 1 to 6.

In a preferred embodiment, the operating pressure of the method of the invention is in the range of 1-200 bar, preferably in the range of 5-100 bar, further preferably in the range from 10 to 60 bar, and especially preferably in the range from 20 to 40 bar. The operating temperature of the method is in the range of 500-1100° C., preferably of 750-1050° C., further preferably of 800-1000° C., and especially preferably of 850-950° C.

The reactant gas which is used in the first method stage is characterized by its composition in relation to hydrocarbon and carbon dioxide. The hydrocarbon is preferably methane. The reactant gas has a total content of hydrocarbon, preferably methane, and carbon dioxide of greater than 50% by volume, preferably greater than 70% by volume, further preferably greater than 80% by volume, particularly preferably greater than 90% by volume and especially greater than 95% by volume. Preferably, the methane and the carbon dioxide are present in the reactant gas in equimolar or virtually equimolar amounts. A preferred ratio of methane to carbon dioxide is in the range from 4:1 to 1:4, more preferably in the range from 3:1 to 1:3 and even more preferably in the range from 2:1 to 1:2. The most preferred ratio of methane to carbon dioxide is close to 1:1. If the hydrocarbon-containing starting gas is ethane, carbon dioxide and ethane are preferably present in a molar ratio of 2:1.

In a preferred embodiment of the method of the invention, the reforming method is preceded by an activation process. The activation process makes it possible to adjust the catalysts to the desired process parameters under controlled conditions.

The activation process comprises the thermal treatment of the catalysts in a reducing gas atmosphere at a temperature in the range from 300° C. to 900° C. Preferably, the catalysts are heated to the operating temperature using a controlled heating process. The heating rate is preferably within a range from 1° C./min to 30° C./min, preference being given to a range from 5° C./min to 15° C./min.

Preferably, the activation process is coupled to a conditioning of the catalysts or the conditioning follows downstream of the activation. Conditioning is understood to mean an operation in which the catalysts are brought stepwise toward the process parameters of the target reaction. The conditioning steps effectively prevent uncontrolled coking of the catalysts during the startup.

The conditioning of the catalysts consists, for example, in heating the catalyst to the operating temperature in the presence of methane, water vapor and/or hydrogen and/or carbon dioxide. It is also possible that the catalysts are conditioned in the presence of water vapor.

In a further embodiment of the method, the catalysts are run in directly with the reactant gas and put into the operating state of the method.

In a preferred embodiment, the method of the invention is conducted at high pressure and/or high temperature. The production of water vapor is generally associated with very high costs, especially also when water vapor has to be heated to high temperatures or has to be placed under high pressure. It is an essential aspect of the method of the invention that the method is conducted with only small amounts of water vapor in the reactant gas, which constitutes a very significant advantage of the method of the invention over those methods known from the prior art.

In one embodiment of the method of the invention, it is preferable to conduct the method in plants connected, for example, to a biogas plant, a coking oven offgas plant, or else to plants having an inexpensive natural gas source and carbon dioxide. With regard to the smaller decentralized plants, it can be assumed that these are preferably operated in accordance with the method of the invention at lower operating pressures (i.e. preferably at a pressure of <50 bar, further preferably <40 bar) than is the case in industrial scale plants. Also conceivable in conjunction with plants in areas of mineral oil or gas production sources, in which no water vapor is available or the provision of water vapor would be costly. The production of water vapor for the performance of reforming method as in accordance with the prior art, i.e. using a high proportion of water vapor, may be associated with great cost and inconvenience in these areas, which has not seemed worthwhile to date from an economic and technical point of view.

In a preferred embodiment, method stages (i) and (ii) are conducted in one reaction space, preferably reaction tube, wherein catalyst for method stage (i) and catalyst for method stage (ii) are in spatial proximity, preferably in direct physical contact (see FIG. 2).

It is within the scope of the method of the invention when the volume of the catalyst used in the first method stage, based on the total volume of catalyst, has a proportion by volume in the range from 5% to 60% by volume, further preferably a proportion by volume in the range of 10-45% by volume, and further preferably a proportion by volume in the range of 10-30% by volume. The proportion by volume of the catalyst used in the second and further method stages (based on the total volume of all the catalysts used) is in the range from 40% to 95% by volume, further preferably of 55-90% by volume, and further preferably of 70-90% by volume. Preferably, the proportion of precious metal catalyst is lower than the proportion of non-precious metal catalyst, although such an execution is not supposed to constitute a restriction in relation to the method.

The catalysts in spatial proximity to one another—i.e. the precious metal catalyst and the non-precious metal catalyst, may also be arranged in the reaction space, for example, such that a portion of the catalyst, preferably the non-precious metal catalyst, can be exchanged and the other portion of the catalyst, preferably the precious metal catalyst, can be regenerated.

The spatial proximity in the performance of the method of the invention is preferable for process technology reasons. One reason for this is that the arrangement of the catalysts for the first method step and the second method step in the same combustion chamber is to be regarded as technically advantageous. By contrast, it is not ruled out that gases are added to product gas 1 obtained in the first method step in order to obtain the desired composition in terms of carbon monoxide-to-hydrogen ratio in product gas 2. However, the addition of gas to product gas 1 is just one method variant among a multitude of possible method variants.

### I. Precious Metal Catalyst (Cat. 1) of the First Method Stage

In a preferred embodiment, it is a characteristic feature of the method of the invention that the precious metal catalyst (cat. 1) comprises at least one precious metal component from the group of Pt, Rh, Ru, Ir, Pd and/or Au.

In a preferred embodiment, it is a characteristic feature of the method of the invention that the precious metal catalyst (cat. 1) comprises at least iridium as precious metal component, the content of the iridium-containing precious metal component preferably being ≦3% by weight, further preferably ≦2% by weight, even further preferably ≦1% by weight and especially preferably ≦0.5% by weight. The percentages stated here are based solely on the amount of precious metal catalysts.

It should be emphasized that these are very low precious metal contents. It is a characteristic feature of the method of the invention that a very small amount of precious metal is sufficient to conduct the method, which enables a considerable decrease in precious metal compared to the methods known from the prior art.

In this connection, it should be pointed out that the precious metal components are present on a catalyst support material, the catalyst support material having high thermal stability. The catalyst support material preferably comprises an oxidic support material, further preferably an oxidic support material including at least one component from the group of Al, Ti, Zr, Mg, Si, Ca, La, Y, Ce.

Suitable supports for the precious metal components include oxides which may comprise one or more of the following oxides: gamma, delta, theta, and alpha aluminum oxide (Al₂O₃), calcium oxides (CaO), magnesium oxide (MgO), barium oxide (BaO), strontium oxide (SrO), monoclinic and tetragonal/cubic zirconium oxide (ZrO₂), scandium oxide (Sc₂O₃), rare earth oxides of yttrium, lanthanum, cerium, praseodymium, neodymium, samarium, gadolinium, dysprosium, erbium and ytterbium, and combinations of these oxides and complex oxidic phases such as spinels, perovskites, pyrochlores, fluorites, magnetoplumbites, hexaaluminates and yttrium-aluminum garnets.

The catalyst of the invention can be produced by impregnation coating of the support material with the individual components. In a further and advantageous configuration of the preparation method, the active components are applied to pulverulent support material which is then at least partly kneaded and extruded.

The precious metal catalyst (cat. 1) may be present on shaped bodies, these being selected from the group of tablets, extrudates, strand extrudates, pellets, beads, monoliths and honeycombs. Monolith or honeycomb may consist of metal or ceramic. The shaping of the active composition or the application of the active composition on a support or support bodies is of great technical significance for the fields of use of the catalyst of the invention. According to the particle size and reactor packing, the shape and arrangement of the particles affect the pressure drop which is caused by the fixed catalyst bed.

The production of shaped bodies from pulverulent raw materials can be effected by methods known to those skilled in the art, for example tableting, aggregation or extrusion, as described, inter alia, in Handbook of Heterogeneous Catalysis, Vol. 1, VCH Verlagsgesellschaft Weinheim, 1997, p. 414-417.

In a preferred embodiment of the method of the invention, it is a characteristic feature of the precious metal catalyst (cat. 1) that it comprises at least iridium as active component and zirconium dioxide-containing support material, where
a) the Ir content in relation to the zirconium dioxide-containing active composition is within a range of 0.01-10% by weight, preferably of 0.05-5% by weight and further preferably of 0.1-1% by weight and
b) the zirconium dioxide in the zirconium dioxide-containing support material is present predominantly, by x-ray diffractometry analysis, in the cubic and/or tetragonal structure, the proportion of cubic and/or tetragonal phase being >50% by weight, further preferably >70% by weight and especially preferably >90% by weight.

In a preferred embodiment of the catalyst of the invention, the zirconium dioxide-containing active composition has a specific surface area of >5 m²/g, preferably >20 m²/g, further preferably 50 m²/g and especially preferably >80 m²/g. The specific surface area of the catalyst was determined by gas adsorption by the BET method (ISO 9277:1995).

It is particularly advantageous that the iridium is in finely distributed form on the zirconium dioxide support, since this achieves a high catalytic activity at a low content of Ir.

In a preferred embodiment, it is a characteristic feature of the catalyst of the invention that the Ir is present on the zirconium dioxide-containing support and the latter is doped with further elements. For doping of the zirconium dioxide support, preferably elements from the group of the rare earths (i.e. from the group of Sc, Y, La, Ce, Pr, Nd, Sm, Eu, Gd, Tb, Dy, Ho, Er, Tm, Yb, Lu), group IIa (i.e. from the group of Mg, Ca, Sr, Ba), group IVa (i.e. from the group of Si), group IVb (i.e. from the group of Ti, Hf), group Vb (i.e. from the group of V, Nb, Ta) of the Periodic Table or the oxides thereof are selected.

Further doping elements may include: platinum metals such as Pt, Pd, Ru, Rh, base metals such as Ni, Co and Fe, other metals such as Mn or other promoters known to those skilled in the art.

If the catalyst, in addition to Ir and zirconium dioxide, also comprises one or more doping elements from the group of the rare earths, the proportion by weight of doping elements based on the total weight of the catalyst is in the range from 0.01% to 80% by weight, preferably in the range from 0.1% to 50% by weight and especially preferably in the range from 1.0% to 30% by weight.

The iridium catalysts which are used with preference in the method of the invention are described in EP application no. 12174258.9 with priority date Jun. 29, 2012. The inventors nominated are E. Schwab, A. Milanov et al. However, the method of the invention is not restricted to the use of these catalysts.

### II. Non-Precious Metal Catalysts (Cat. 2, 3) of the Further Method Stages

In a preferred embodiment, the non-precious metal catalysts of the second and further method stages comprise at least one active metal from the group of nickel and/or cobalt.

It is a characteristic feature of the non-precious metal catalysts of the second and further method stages that they catalyze the reaction of hydrocarbons with carbon dioxide and/or water vapor to give synthesis gas under very demanding conditions without coking.

In a preferred embodiment of the method of the invention, non-precious metal catalysts (cat. 2, cat. 3, etc.) used in the further method stages are those which effectively convert these hydrocarbons with carbon dioxide and/or water vapor to give synthesis gas without coking, the water vapor content or the sum total of water vapor and hydrogen in the gas mixture to be converted (product gas 1 or product gas 1 and further gases) being in the range from 3% to 60% by volume, preferably in the range from 5% to 50% by volume, further preferably in the range from 7% to 30% by volume, further preferably from 8% to 25% by volume and especially preferably in the range from 9% to 23% by volume. In other words, the stated ranges are based only on water vapor if a hydrogen-free product gas is present or on the sum total of water vapor and hydrogen if a product gas comprising both water vapor and hydrogen is present. It should also be mentioned that it is the first product gas to which gases can but need not necessarily be added.

In a preferred embodiment of the method of the invention, it is a characteristic feature of the non-precious metal catalyst that it comprises nickel present in very highly dispersed form on a support oxide, and that the support oxide consists of or comprises very small particles of magnesium spinel (MgAl₂O₄).

In a preferred embodiment of the method of the invention, the non-precious metal catalyst support comprises a magnesium spinel that is in intimate contact with a mixed oxide phase composed of nickel and magnesium. It is a characteristic feature of this catalyst or catalyst precursor that both the nickel-containing phase and the spinel-containing phase have very small crystallite sizes. In the case of the spinel-containing phase, the mean crystallite size is <100 nm, the mean crystallite size preferably being ≦70 nm, and the mean crystallite size further preferably being ≦40 nm.

In one embodiment which is particularly preferred, the non-precious metal catalyst comprises at least the three phases of mixed nickel-magnesium oxide, magnesium spinel and aluminum oxide hydroxide and has the characteristic feature that the mixed nickel-magnesium oxide has a mean crystallite size of ≦100 nm, preferably ≦70 nm, further preferably ≦40 nm, and the magnesium spinel phase has a mean crystallite size of ≦100 nm, preferably ≦70 nm, further preferably ≦40 nm, and a nickel content in the range of 6-30 mol % and a magnesium content in the range of 8-38 mol %, preferably in the range of 23-35 mol %. The aluminum content is preferably in the range of 50-70 mol %, and the BET surface area in the range of 10-200 m²/g.

It is a characteristic feature of the phase composition of a particularly preferred catalyst that the intensity of the reflection at 43.15°±0.15° 2θ (2 theta) (d=2.09±0.01 A) is less than or equal to the intensity of the reflection at 44.83±0.20° 2 θ (d=2.02±0.01 A), the intensity of the reflection at 43.15°±0.15° 2θ (2 theta) (d=2.09±0.01 A) further preferably being less than the intensity of the reflection at 44.83±0.20° 2θ (d=2.02±0.01 A), and, even further preferably, the intensity ratio of the two reflections I_{(43.15°)}/I_{(44.83°)} being from 0.3 to 1.0, preferably from 0.5 to 0.99, more preferably from 0.6 to 0.97, and especially preferably from 0.7 to 0.92. The above-described nickel catalysts feature an improved profile of properties which is manifested both in an improved long-term sintering stability and in improved coking characteristics under the demanding conditions of the second and further method stages of the method of the invention. The abovementioned nickel catalysts can be prepared, for example, by the method described in the PCT application WO2013/068905A1, which claims Nov. 8, 2011 as its priority date.

In a further-preferred embodiment of the method of the invention, it is a characteristic feature of the non-precious metal catalyst that it comprises cobalt and at least one further element from the group of Ba, Sr, La, where the Co content is in the range of 2-15 mol %, preferably 3-10 mol % and further preferably in the range of 4-8 mol %, the content of the at least one further element from the group of Ba, Sr, La is within a range of 2-25 mol %, preferably 3-15 mol %, further preferably 4-10 mol %, and the content of Al is within a range of 70-90 mol %.

It is a characteristic feature of the cobalt catalyst which is used with preference in the second and further method stages of the method of the invention that the catalyst comprises a hexaaluminate phase. The expression “hexaaluminate phase” encompasses phases having laminar structures similar or identical to the magnetoplumbite structure types and/or beta-aluminate structure types such as the beta′-aluminate or beta″-aluminate structure. If the catalyst comprises secondary phases, the proportion of secondary phase is within a range of 0-50% by weight, preferably within a range of 3-40% by weight and further preferably within a range of 5-30% by weight. Preferably, the secondary phase consists of oxides, these further preferably being from the group of alpha-aluminum oxide, theta-aluminum oxide, LaAlO₃, BaAl₂O₄, SrAl₂O₄, CoAl₂O₄, La-stabilized aluminum oxide and/or La-stabilized aluminum oxide hydroxide.

For the process of the invention, particular preference is given to those cobalt hexaaluminate catalysts wherein the molar ratio of cobalt to aluminum (i.e. the n_{Co}/n_{Al} ratio) is in the range from 0.05 to 0.09 and more preferably in the range from 0.06 to 0.08. In a preferred configuration of the method of the invention, the molar ratio of M^{BaSrLa} to aluminum (i.e. the n_{MBaSrLa}/n_{Al} ratio) in the cobalt hexaaluminate catalyst used is within a range from 0.09 to 0.25, more preferably within the range from 0.092 to 0.20. Preferably, the molar ratio of Co to M^{BaSrLa} (i.e. the n_{Co}/n_{MBaSrLa} ratio) is in the range from 1.0 to 0.3 and more preferably in the range from 0.85 to 0.40. The abbreviation M^{BaSrLa} indicates that at least one element from the group of Ba, Sr, La is present.

The above-described cobalt catalysts feature an improved profile of properties which is manifested both in improved long-term sintering stability and in improved coking characteristics under the demanding conditions of the second and further method stages of the method of the invention. The abovementioned cobalt catalysts can be prepared, for example, by the method described in the PCT application WO 2013/118078A1 (the priority date of the application is Feb. 10, 2012).

In a further-preferred embodiment of the method of the invention, it is a characteristic feature of the non-precious metal catalyst that it comprises at least 65-95% by weight, preferably 70-90% by weight, of nickel hexaaluminate and 5-35% by weight, preferably 10-30% by weight, of crystalline oxidic secondary phase, where the nickel content of the catalyst ≦8 mol %, preferably ≦7 mol %, further preferably ≦6 mol %, even further preferably ≦3 mol %, particularly preferably ≦2.5 mol % and especially preferably ≦2 mol %, the nickel hexaaluminate-containing phase at least one interplanar cation from the group of Ba, Sr and/or La with a molar interplanar cation-to-aluminum ratio in the range of 1:6-11, preferably of 1:7-10 and especially preferably of 1:8-10, the crystalline oxidic secondary phase comprises at least LaAlO₃, SrAlO₄ and/or BaAlO₄, BET surface area of the catalyst is ≦5 m²/g, preferably ≦10 m²/g. The figure for the molar nickel content relates to the consideration of the elements present in the catalyst that form cations, i.e. Al, Ni and interplanar elements. Thus, the presence of oxygen is not taken into account. In the context of the present disclosure, in the stated ranges of the molar ratios of aluminum to interplanar cation, it should be noted that the molar amount of interplanar cation also includes the respective molar amount of nickel.

Preferably, the nickel hexaaluminate catalyst comprises at least 65-95% by weight, preferably 70-90% by weight, of nickel hexaaluminate in the form of β″-aluminate with a [114] reflection at 35.72 2θ [°] and/or magnetoplumbite and 5-35% by weight, preferably 10-30% by weight, of crystalline oxidic secondary phase, the latter further preferably comprising oxides from the group of alpha-aluminum oxide, theta-aluminum oxide, LaAlO₃, BaAl₂O₄, SrAl₂O₄, CoAl₂O₄, La-stabilized aluminum oxide and/or La-stabilized aluminum oxide hydroxide.

The method of the invention makes it possible to produce a synthesis gas that has a suitable hydrogen-to-carbon monoxide ratio which is preferably in the range from 0.5 to 2, further preferably ≦1.5 and especially preferably ≦1.2. In each individual case, the target composition of the synthesis gas in that case also depends on the specific process for which the synthesis gas is used the downstream plants. Examples of possible downstream processes include methanol synthesis, direct dimethyl ether synthesis, gas-to-liquid syntheses or Fischer-Tropsch methods for synthesis of longer-chain hydrocarbons, or the production of particular monomers or other components.

### BRIEF DESCRIPTION OF THE FIGURES

FIG. 1 shows a schematic diagram with two separate reactors connected in series. The outlet conduit of the first reactor is connected to the inlet conduit of the second reactor.

FIG. 2 shows a schematic diagram of a reactor charged with a first catalyst material and a second catalyst material. The first catalyst material (the precious metal catalyst) is in the upper region of the reactor and the second catalyst material (the non-precious metal catalyst) is in the lower region of the reactor. The flow of gas or reactant gas through the reactor is from the top downward.

FIG. 3 shows a schematic diagram of four reactors with structured catalyst beds, with the reactors arranged in parallel. The flow through the reactors is from the top downward, with contact of the reactant gas first with catalyst 1 and then with catalyst 2.

FIG. 4 shows a schematic diagram of two reactors connected in series, of which the first is charged with catalyst 1 and the second with catalyst 2. By contrast with the representation in FIG. 1, the reactant gas feed has a connecting conduit which leads to product gas conduit 1, which leads into the second reactor. This allows a reactant gas to be added to product gas 1.

FIG. 5 shows a diagram of the same reactor shown in FIG. 2, except that the reactor is charged with three different catalyst materials. Catalyst 1 is disposed in the first bed layer, catalyst 2 in the second bed layer and catalyst three in the third bed layer.

FIG. 6 shows a diagram of the reactor shown in FIG. 1, with the product gas conduit equipped with a further gas feed conduit. By means of the gas feed conduit, it is possible to add gas to product gas 1. For example, this may be the feeding of recycle gas.

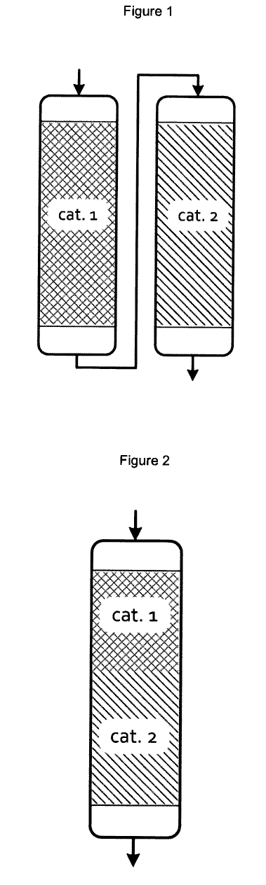

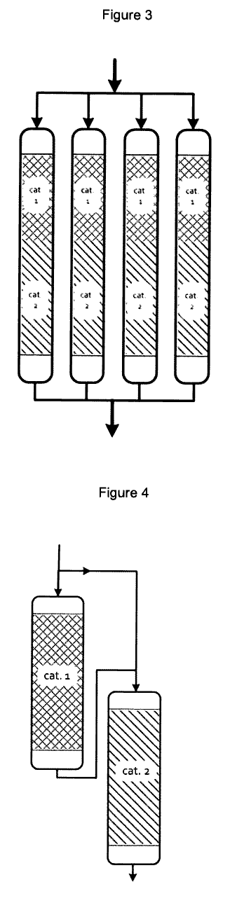

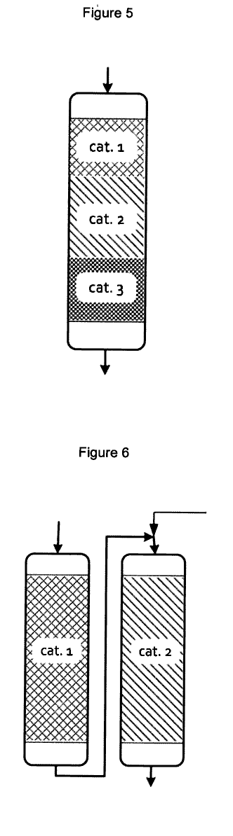

### III. EXAMPLES

### Preparation of the Example Samples

### Preparation of Precious Metal Catalysts for the First Stage of the Method of the Invention:

For preparation of the catalyst of the invention (cat. 1b), 198 g of yttrium-stabilized zirconium dioxide were impregnated with aqueous iridium chloride solution. First of all, to prepare the iridium chloride solution, 3.84 g of IrCl₄*H₂O were dissolved in 20 mL of distilled water and the solution was made up with water. The amount of water had been chosen to be able to fill 90% of the free pore volume of the support oxide with the solution. The free pore volume was 0.2 cm³/g. The yttrium-stabilized zirconium dioxide had an yttrium oxide content (Y₂O₃) of 8% by weight and was in the form of spell having a particle size in the range of 0.5-1.0 mm. The spall of stabilized support oxide was initially charged in an impregnating drum and spray-dried with the iridium chloride solution while being circulated. After the impregnation, the material was circulated for a further 10 minutes and then dried in an air circulation drying cabinet at 120° C. for 16 hours. The calcination of the dried material was effected at 550° C. for two hours. The iridium catalyst S2 obtained here had an iridium content of 1.0 g of iridium per 100 g of catalyst.

The iridium catalysts cat. 1a and cat. 1c were synthesized by the procedure described for cat. 1 b using corresponding support (in other words, an yttrium-stabilized support in the case of cat. 1c and a Ce/La-stabilized support in the case of cat. 1a.)

Table 1 shows a summary of the compositions of the active compositions tested and the metal content.

| | Iridium content | | | Stabilizer content |
|---|---|---|---|---|
| Sample | [% by wt.] | Support | Stabilizer | [% by wt. as oxide] |
| cat. 1a | 2 | ZrO₂ | Ce, La | 22 |
| cat. 1b | 1 | ZrO₂ | Y | 8 |
| cat. 1c | 0.1 | ZrO₂ | Y | 8 |

### Preparation of Non-Precious Metal Catalysts for the Second and Further Stages of the Method of the Invention:

The preparation of the mixed nickel-magnesium oxide on magnesium-aluminum spinel catalysts used was effected by the method described in WO 2013/068905A1. For the preparation of cat. 2a, 261.7 g of pulverulent nickel nitrate hexahydrate (Ni(NO₃)₂*6H₂O from Merck) were initially charged in a beaker and melted at a temperature of about 100° C. by heating by means of a hotplate. Subsequently introduced into the beaker containing the nitrate salt melt were 400 g of preheated hydrotalcite powder, with mixing of the nitrate salt melt during the introduction of the hydrotalcite by means of a mechanical stirrer on a hotplate. The stirrer motor was arranged above the opening of the beaker. The hydrotalcite used was Pural MG30 from Sasol. Prior to the introduction of the hydrotalcite, it had been heated in an air circulation oven at 130° C. for 30 minutes. The introduction of the hydrotalcite into the melt was conducted in a plurality of steps and over a total period of 10 minutes. The beaker containing the mixture of hydrotalcite and salt melt was subjected to heat treatment in the oven at 130° C. for 30 minutes, followed by mixing with a stirring tool for about 5 minutes and with an Ultra-Turrax stirrer for a further 2 minutes.

After cooling, the mixture of nitrate salt and hydrotalcite obtained here was divided into two portions of about 330 g, each of which was then subjected to low-temperature calcination in a rotary sphere furnace. For this purpose, the samples were introduced into a quartz glass bulb which was secured in the rotary sphere furnace and rotated at a speed of rotation of 12 revolutions per minute while passing through an air stream of 1 L/min. The quartz bulb containing the sample mixture was heated stepwise through three different temperature levels of 120° C., 180° C. and 280° C. to a target temperature of 425° C. The residence time of the sample at each of the individual temperature levels of the heating phase and at the target temperature was 2 hours. The heating rate used was 2° C./minute. The product obtained in the low-temperature calcination was mixed with (5% by weight) of lubricant and pressed to tablets with a mechanical ram press (XP1 from Korsch) employing a compression force in the range from 30 to 35 kN.

Lubricants used may, for example, be graphite, stearic acid or magnesium stearate. The tablets obtained here had a diameter of 13 mm and a thickness of about 4-5 mm. The tablets were pre-comminuted with a rotary sieve mill at a speed of rotation of 70 rpm and pressed through a sieve. The pre-comminuted material was then sieved in order to separate out the target fraction having a particle size of 500 to 1000 μm. The sieving was effected with a sieving machine from Retsch (model: AS 200) using an agitation frequency of 60 Hz. The material obtained in the sieving was subjected to a high-temperature calcination at 950° C. For this purpose, the sample material was heated to 950° C. in a muffle furnace while passing an air stream (of 6 L/min) through it and using a heating rate of 5° C./minute, subjected to heat treatment at 950° C. for 4 hours and then cooled down to room temperature.

The preparation of the cobalt hexaaluminate catalysts was effected by the method described in WO 2013/118078A1. To prepare the catalyst cat, 2b, first of all, cobalt nitrate and a lanthanum nitrate present in a beaker are admixed with 250 mL of distilled water and dissolved completely. The cobalt nitrate is 83.1 g of Co(NO₃)₃×6H₂O and the lanthanum nitrate is 284.9 g of La(NO₃)₃×6H₂O. The metal salt solution is admixed with 250 g of boehmite, whereupon a suspension forms. The boehmite used is Disperal from SASOL.

The suspension is stirred with a mechanically driven stirrer for a period of 15 minutes, the stirrer speed being indicated as 2000 rpm. Subsequently, the suspension is added dropwise by means of a pipette to a cold bath of liquid nitrogen, in order to freeze out virtually spherical particles having a particle diameter of 5 mm. The frozen suspension particles are first dried with a freeze-drying system and then pressed through a sieve for comminution. The mesh size of the sieve used here is 500 μm.

After the freeze-drying and comminution, the material is pre-calcined in a furnace at 520° C. Thereafter, the calcined material is pressed to tablets with a ram press, and the tablets are then comminuted and forced through a sieve of mesh size 1 mm. The tablets have a diameter of 13 mm and a thickness of 3 mm. The target fraction has a particle size of 500 to 1000 μm.

For high-temperature calcination, the material obtained after the sieving is heated in a muffle furnace at 1100° C. for 30 hours, in the course of which an air stream of 6 liters/minute is passed over the material. The oven is heated to the temperature of 1100° C. at a heating rate of 5° C.

Table 2 shows a summary of the molar compositions of the tested catalysts cat. 2a and cat. 2b and the corresponding BET surface areas of the samples.

| | | | | SA |
|---|---|---|---|---|
| Sample | M₁/mol % | M₂/mol % | M₃/mol % | [m²/g] |
| cat. 2a | Ni/14 mol % | Mg/29 mol % | Al/57 mol % | 42 |
| cat. 2b | Co/6 mol % | La/14 mol % | Al/80 mol % | 8.3 |

### Catalytic Studies

In the examples for the invention, the examples for the at least first method stage and the examples for the at least second method stage are cited, these having been achieved in independent catalytic studies. These examples serve merely to illustrate that the method of the invention is industrially implementable in the form described in the present context. The preferred spatial proximity of the precious metal (of the first method stage) and the non-precious metal (in the second method stage) in a reactor and the temporal proximity in the performance of these experiments do not exist in the present context. However, the person skilled in the art will directly and unambiguously infer the implementability of the method of the invention therefrom.

I. Catalytic Method that Illustrates the First Method Stage

The catalytic studies relating to the reforming of a hydrocarbonaceous gas in the presence of CO₂, which illustrate the first stage of the method of the invention, have been conducted by means of a catalyst test bench equipped with six reactors arranged in parallel. In preparation for the studies, the individual reactors were each filled with 20 mL of catalyst sample.

An overview of the catalytic studies conducted with the iridium catalysts cat. 1a, cat. 1 b and cat. 1c is shown in table 3. First of all, the reactors filled with the catalysts were heated to the target temperature in a controlled manner under carrier gas atmosphere at 25° C. The carrier gas used was nitrogen. (It is conceivable to undertake the heating in the presence of a reducing gas atmosphere.) For heating of the reactors, a heating rate of 10° C./min was chosen. After the reactors containing the catalysts had been stored at the target temperature in a nitrogen stream for 0.5 h, they were exposed to the reforming gas.

In the course of the catalytic study, the individual samples were subjected to a sequence of different test conditions. In the first test conditions of sequence (c1), the catalyst cat. 1 b was stored at 850° C. and exposed to an input gas which comprised equimolar amounts of CH₄/CO₂ and no water vapor. Subsequently, catalysts cat. 1a, cat. 1 b and cat. 1c were heated to 950° C. and exposed to a reforming gas comprising 10% by volume of water vapor and equimolar proportions of CH₄ and CO₂ (test conditions c2). Finally, the water vapor content of the reforming gas was reduced from 10% by volume to 0% by volume, which corresponded to test conditions c3. All the catalytic studies were conducted in the presence of 5% by volume of argon as internal standard, which was supplied to the reactant fluid for analytical reasons in order to monitor the material recovery rate.

The iridium catalysts of examples cat. 1a to cat. 1c which were used in conjunction with the method of the invention and which were tested at 850-950° C. in the presence of 10% by volume and finally 0% by volume of water vapor did not exhibit any deactivation and/or coking and a very high conversion of CO₂ and CH₄. The product gas mixtures thus obtained comprise up to 15% by volume of water vapor and/or up to 50% by volume of hydrogen and water vapor in total. The water vapor or water vapor plus hydrogen content in the product gas is a function of the CH₄ conversion attained and is additionally affected by the temperature (influence on the equilibrium position of the reforming and water-gas shift reactions).

The test conditions chosen in the present case were so demanding in terms of the physicochemical conditions that it was only possible at all by means of the iridium catalyst samples used to achieve high conversions and stable performance properties over a prolonged period.

Table 3 shows a summary of the reaction conditions and the conversions achieved for the iridium catalysts cat. 1a, cat. 1b and cat. 1c. The reforming gas used had an equimolar ratio of CH₄ and CO₂ and 5% by volume of argon as internal standard. All experiments were conducted at a temperature of 850-950° C. and reactor pressure of 20 bar.

| | Test conditions/input gas | | | | | | | |
|---|---|---|---|---|---|---|---|---|
| | | CH₄ | CO₂ | H₂O | H₂ | Results | | |
| | | [% | [% | [% | [% | CH₄ | CO₂ | H₂/ |
| | Temp. | by | by | by | by | conv. | conv. | CO |
| Catalyst | [° C.] | vol.] | vol.] | vol.] | vol.] | [%] | [%] | ratio |
| cat. 1b_c1 | 850 | 47.5 | 47.5 | 0 | 0 | 55 | 73 | 0.7 |
| cat. 1a_c2 | 950 | 42.5 | 42.5 | 10 | 0 | 80 | 80 | 0.9 |
| cat. 1b_c2 | 950 | 42.5 | 42.5 | 10 | 0 | 82 | 83 | 0.9 |
| cat. 1c_c2 | 950 | 42.5 | 42.5 | 10 | 0 | 80 | 82 | 0.9 |
| cat. 1a_c3 | 950 | 47.5 | 47.5 | 0 | 0 | 75 | 87 | 0.8 |
| cat. 1b_c3 | 950 | 47.5 | 47.5 | 0 | 0 | 75 | 88 | 0.8 |
| cat. 1c_c3 | 950 | 47.5 | 47.5 | 0 | 0 | 35 | 51 | 0.5 |

The input gas comprises 5% by vol. of argon as internal standard.

II. Catalytic Method that Illustrates the at Least Second Method Stage

The catalytic studies relating to the reforming of a hydrocarbonaceous gas in the presence of 002, which illustrate the second and further stages of the method of the invention, were likewise conducted by means of a catalyst test bench which was equipped with six reactors arranged in parallel. In preparation for the studies, the individual reactors were each filled with 20 mL of catalyst sample. The studies were conducted in the presence of 5% by volume of argon as standard gas, which was added to the reactant fluid for analytical reasons in order to monitor the material recovery rate.

A summary of the process conditions to which catalysts cat. 2a and cat. 2b were subjected and the results achieved in the reforming studies are reproduced in table 4.

In relation to the catalytic studies, it should be stated that the test conditions were altered stepwise during the study, with gradual reduction of the proportion of hydrogen in the input gas in test phases s1-s5 from 40% by volume to 10% by volume. In phases s6 and s7, first a portion and then the complete amount of hydrogen was replaced by water vapor. The stepwise alteration in the hydrogen content in the input gas simulated a change in the CH₄/CO₂ conversion in the first method stage. While 40% by volume of H₂ or H₂+H₂O corresponds to a CH₄/CO₂ conversion of about 70%, the test conditions with 10% by volume of H₂ and/or 10% by volume of H₂+H₂O and/or 10% by volume of H₂O are representative of a CH₄/CO₂ conversion of about 10%. In the experiments, for safety reasons, no carbon monoxide was added to the input gas.

The catalysts studied, cat. 2a and cat. 2b, exhibited high activity and very good long-term stability and coking resistance under the test conditions s1-s7 studied. The test conditions chosen in the present context were so demanding in terms of the physicochemical conditions that it was only possible at all by means of the nickel- and cobalt-containing catalyst samples used to achieve high conversions and stable performance properties over a prolonged period.

Table 4 shows a summary of the reaction conditions and the conversions achieved for the nickel and cobalt catalysts cat. 2a and cat. 2b. The reforming gas used had an equimolar ratio of CH₄ and CO₂ and 5% by volume of argon as internal standard. All experiments were conducted at a temperature of 850-950° C. and reactor pressure of 20 bar.

| | Test conditions/input gas | | | | | | | |
|---|---|---|---|---|---|---|---|---|
| | | CH₄ | CO₂ | H₂O | H₂ | Results | | |
| | | [% | [% | [% | [% | CH₄ | CO₂ | |
| | Temp. | by | by | by | by | conv. | conv. | H₂/CO |
| Catalyst | [° C.] | vol.] | vol.] | vol.] | vol.] | [%] | [%] | ratio |
| cat. 2a_s1 | 850 | 27.5 | 27.5 | 0 | 40 | 46 | 78 | 1.5 |
| cat. 2b_s1 | 850 | 27.5 | 27.5 | — | 40 | 30 | 74 | 1.6 |
| cat. 2a_s2 | 850 | 32.5 | 32.5 | 0 | 30 | 49 | 76 | 1.2 |
| cat. 2b_s2 | 850 | 32.5 | 32.5 | — | 30 | 38 | 74 | 1.2 |
| cat. 2a_s3 | 950 | 32.5 | 32.5 | 0 | 30 | 66 | 78 | 1.1 |
| cat. 2b_s3 | 950 | 32.5 | 32.5 | — | 30 | 65 | 90 | 1.3 |
| cat. 2a_s4 | 950 | 37.5 | 37.5 | 0 | 20 | 64 | 73 | 1.0 |
| cat. 2b_s4 | 950 | 37.5 | 37.5 | — | 20 | 68 | 90 | 1.1 |
| cat. 2a_s5 | 950 | 42.5 | 42.5 | 0 | 10 | 57 | 67 | 0.8 |
| cat. 2b_s5 | 950 | 42.5 | 42.5 | — | 10 | 70 | 88 | 0.9 |
| cat. 2a_s6 | 950 | 42.5 | 42.5 | 5 | 5 | 67 | 67 | 0.8 |
| cat. 2b_s6 | 950 | 42.5 | 42.5 | 5 | 5 | 74 | 85 | 0.9 |
| cat. 2a_s7 | 950 | 42.5 | 42.5 | 10 | 0 | 82 | 74 | 0.9 |
| cat. 2b_s7 | 950 | 42.5 | 42.5 | 10 | — | 85 | 75 | 1.15 |

The input gas comprises 5% by vol. of argon as internal standard.

The studies undertaken with cat. 2a and cat. 2b were each ended after a cumulative run time of more than one thousand hours and the samples were deinstalled from the reactor tube. None of the samples recovered after the study had coke deposits. The results are therefore a further finding that demonstrates the extremely high coking resistance of the catalysts used under the severe process conditions that exist in table 4. At the same time—as can be inferred from table 4—it was possible to obtain a product stream in the catalysis experiments that had an advantageous ratio of H₂ to CO.

1. A method of reforming gas mixtures comprising hydrocarbons and CO₂, the method comprising:
(i) contacting reactant gas with precious metal catalyst and converting it to a first product gas,
(ii) contacting the first product gas with non-precious metal catalyst in a second stage to convert the first product gas to a second product gas.

2. The method of reforming the gas mixture according to claim 1, wherein a gas is added to the product gas of the first and/or second stage, said addition gas being reactant gas and/or recycle gas, and the proportion of addition gas which is added to the first and/or second product gas is in the range of 0.1%-70% by volume.

3. The method of reforming the gas mixture according to claim 1, wherein the reactant gas used for the first stage has a ratio of water vapor to carbon atoms (i.e. an n_{H2O}/n_{c.a.n.} ratio) of less than 0.5.

4. The method of reforming the gas mixture comprising hydrocarbons and CO₂ according to claim 1, wherein the total content of water vapor in the reactant gas is less than 25% by volume.

5. The method of reforming the gas mixture according to claim 1, wherein the reactant gas comprises hydrogen, the hydrogen content being less than 20% by volume.

6. The method of reforming the gas mixture according to claim 1, wherein the hydrocarbon conversion which is achieved in the first stage is in the range of 2%-60%.

7. The method of reforming the gas mixture according to claim 1, wherein the first product gas has a total content of hydrogen and water vapor in the range of 5%-50% by volume.

8. The method of reforming the gas mixture according to claim 1, wherein the operating pressure is in the range of 5-100 bar and the operating temperature is in the range of 750-1050° C.

9. The method of reforming the gas mixture according to claim 1, wherein the hydrocarbon is methane and the ratio of methane to carbon dioxide is in the range from 4:1 to 1:4, or the hydrocarbon is ethane, and ratio of ethane to carbon dioxide is in a molar ratio of 2:1.

10. The method of reforming the gas mixture according to claim 1, wherein the catalyst volume used in the first stage based on the total volume of catalyst has a proportion by volume in the range of 5%-60% by volume, the proportion by volume of the catalyst used in the second stage is in the range of 40%-95% by volume.

11. The method of reforming the gas mixture according to claim 1, wherein the precious metal catalyst comprises at least one precious metal selected from Pt, Rh, Ru, Ir, Pd, Au or any one mixture thereof.

12. The method of reforming the gas mixture according to claim 1, wherein the precious metal catalyst comprises at least iridium, the content of iridium-containing precious metal component being ≦3% by weight, and the iridium-containing precious metal component is on a zirconium dioxide-containing support having a cubic and/or tetragonal phase, where the proportion of cubic and/or tetragonal phase is greater than 50% by weight and optionally the iridium-containing catalyst of the first stage comprises, as stabilizer, one or more rare earth elements selected from the group consisting of Sc, Y, La, Ce, Pr, Nd, Sm, Eu, Cd, Tb, Dy, Ho, Er, Tm, Yb, and Lu, where the proportion of stabilizer is 1%-30% by weight.

13. The method of reforming the gas mixture according to claim 1, wherein the non-precious metal catalyst of the second stage comprises at least one material selected from nickel spinel, cobalt hexaaluminate, nickel hexaaluminate, or any one mixture thereof.

14. A synthesis gas comprising a hydrogen-to-carbon monoxide ratio in the range of 0.5-2, the synthesis gas produced by the process of claim 1.

15. The synthesis gas according to claim 14 used for preparation of at least one of the following products: methanol, DME, acetic acid, higher alcohols, or Fischer-Tropsch synthesis of long-chain hydrocarbons and olefins.

16. A method of reforming gas mixtures comprising hydrocarbons and CO₂, the method comprising:
contacting reactant gas with precious metal catalyst and converting it to a first product gas, the reactant gas having a ratio of water vapor to carbon atoms (i.e. an n_{H2O}/n_{c.a.n.} ratio) of less than 0.2, and the total content of water vapor in the reactant gas is less than 10% by volume
contacting the first product gas with non-precious metal catalyst in a second stage to convert the first product gas to a second product gas,
providing an addition gas that is added to the first and/or second product gas, the addition gas being reactant gas and/or recycle gas, and the proportion of addition gas which is added to the—first and/or second product gas is in the range of 0.1%-50% by volume.

17. The method of reforming the gas mixture according to claim 16, wherein the reactant gas comprises hydrogen, the hydrogen content being less than 5% by volume.
